(19) United States
(12) Patent Application Publication
(10) Pub. No.: US 2004/0205283 A1
(43) Pub. Date: Oct. 14, 2004

(54) Interface module

(76) Inventor: Pei-Chung Liu, ChungHo City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/397,323

(22) Filed: Mar. 27, 2003

(51) Int. Cl. G06F 13/14

(52) U.S. Cl. 710/315

(57) ABSTRACT

An interface module includes a control circuit including PCI to PS2 interface conversion circuitry, PCI to sound conversion circuitry, and PCI to VGA display interface conversion circuitry. A PCI interface connector is connected to the control circuit for connection of the interface module to a PCI interface slot of a computer. A number of PS2 interface connectors are connected to the PCI to PS2 interface conversion circuitry for selective connection with PS2 peripheral devices. Sound input and output connectors are connected to PCI to sound conversion circuitry for selective connection with sound input and output devices. A VGA connector is connected to the PCI to VGA display interface conversion circuitry for selective connect with a VGA display. Thus, a single interface module allows for connection of a number of peripheral devices to a single PCI interface slot of the computer.

### BACKGROUND OF THE INVENTION

1. Field of the Invention

The present invention relates generally to an interface module, and in particular to a single module for coupling PS2 peripherals, sound input/output devices VGA display and USB peripherals to a host machine of for example a computer system.

2. The Related Art

A computer system comprises a number of interface circuits each embodied in the form of a circuit board, which is generally called an interface card, for communication and connection between a host machine of the computer system and the peripherals. Examples of the interfaces that are commonly incorporated in a computer system include PCI interface, IDE interface, AGP interface and USB interface and each interface has a corresponding interface card mounted in the computer system, such as VGA display card, sound card, and PS2 interface card. The computer system has a number of interface slots for receiving and physically connecting the interface cards to the computer system. The more interface cards there are, the more interface card slots of the computer system are occupied. Thus, the interface cards “occupy” a substantial amount of interior space inside a computer and increase overall costs of the computer system.

Computer systems with interface circuits directly formed on a main board of the computer are also available in the market. The “on-board” interface circuits surely eliminate the costs thereof for mounting/dismounting an interface card to the interface slots on the main board. The most commonly seen on-board interface circuits are PS interface, VGA interface and sound interface. However, adding on-board interface circuits on the main board inevitably increases the overall size or footprint of the main board. Further, malfunctioning interface circuits that are built on board cannot be individually replaced for repairing and the main board must be completely replaced. Adding more interfaces to the main board or upgrading the existing interface circuit is also impossible. Thus, this measure imposes undesired limitations to the application and operation of the interfaces.

To realize multi-tasking operation of a computer system, application software available in the markets allow for sharing of computer resources between different applications. In other words, different users of the computer system may simultaneously operate or execute different application programs built in the computer system. However, such a multi-tasking operation is subject to the limitation of the conventional construction of the computer wherein only limited number of interface circuits can be incorporated in the computer system, which is not sufficient for the simultaneous operation of different application programs by other users.

Another disadvantage associated with the on-board interface circuits is that they are controlled by BIOS of the computer system. This makes it impossible to allow users to drive the interface circuit directly via multi-tasking operating system currently available in the market. Thus, multi-tasking operation of the computer system is in fact not realized in the current computer architecture.

### SUMMARY OF THE INVENTION

Thus, an object of the present invention is to provide an interface module comprising a control circuit comprising PCI to PS2 interface conversion, PCI to sound conversion and PCI to VGA display interface conversion whereby PS2 and USB based peripherals, sound input/output devices and VGA display may communicate with a host computer via a single common interface module. The trouble that a number of interface cards occupy the interface slots on a computer main board is completely eliminated.

Another object of the present invention is to provide an interface module comprising a control circuit to which PS2 interface connector, sound input and output connectors and VGA connector are coupled for respectively connecting PS2 peripherals, sound input/output devices and VGA display to a host computer via the control circuit.

A further object of the present invention is to provide an interface module comprising a control circuit having a PCI interface connector for connection with a PCI interface slot of a host computer whereby the PS2 interface connector, sound input/output connectors and VGA connector that constitute partly the interface module are controlled directly by application software executed in the host computer for sharing the computer resources among different computer users.

To achieve the above objects, in accordance with the present invention, there is provided an interface module comprising a control circuit comprising PCI to PS2 interface conversion circuitry, PCI to sound conversion circuitry, and PCI to VGA display interface conversion circuitry. A PCI interface connector is connected to the control circuit for connection of the interface module to a PCI interface slot of a computer. A number of PS2 interface connectors are connected to the PCI to PS2 interface conversion circuitry for selective connection with PS2 peripheral devices. Sound input and output connectors are connected to PCI to sound conversion circuitry for selective connection with sound input and output devices. A VGA connector is connected to the PCI to VGA display interface conversion circuitry for selective connect with a VGA display. Thus, a single interface module allows for connection of a number of peripheral devices to a single PCI interface slot of the computer

### BRIEF DESCRIPTION OF THE DRAWINGS

The present invention will be apparent to those skilled in the art by reading the following description of preferred embodiments thereof, with reference to the attached drawings, in which:

FIG. 1 is a system block diagram of an interface module constructed in accordance with a first embodiment of the present invention;

FIG. 2 is a system block diagram of an interface module constructed in accordance with a second embodiment of the present invention;

FIG. 3 is a system block diagram of an interface module constructed in accordance with a third embodiment of the present invention;

FIG. 4 is a system block diagram of an interface module constructed in accordance with a fourth embodiment of the present invention;

FIG. 5 is a system block diagram of an interface module constructed in accordance with a fifth embodiment of the present invention;

FIG. 6 is a system block diagram showing a first application of the interface module in accordance with the present invention; and

FIG. 7 is a system block diagram showing a second application of the interface module in accordance with the present invention.

### DETAILED DESCRIPTION OF THE PREFERRED EMBODIMENTS

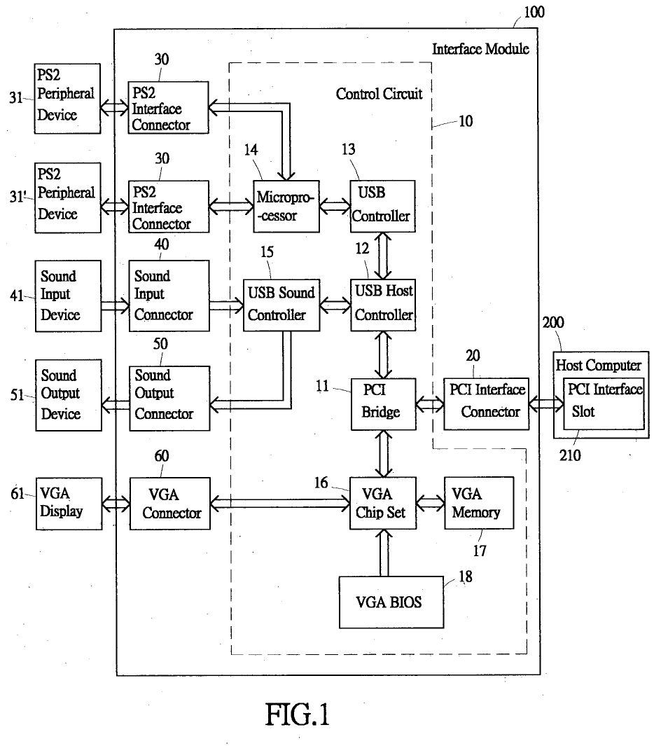

With reference to the drawings and in particular to FIG. 1, an interface module constructed in accordance with a first embodiment of the present invention, generally designated with reference numeral 100, comprises a control circuit 10 to which a PCI interface connector 20, at least one PS2 interface connector 30, at least one sound input connector 40, a sound output connector 50 and a VGA connector 60 are connected. The control circuit 10 comprises a PCI bridge 11, a USB host controller 12, a USB controller 13, a microprocessor 14, a USB sound controller 15, a VGA chip set 16, a VGA memory 17 and VGA BIOS 18.

The PCI bridge 11 provides a PCI interface conversion to the control circuit 10, and is connected to a PCI interface slot 210 of a host computer 200 via the PCI interface connector 20 for transferring PCI-based data and instructions between the control circuit 10 and the host computer 200.

The USB host controller 12 is connected to the PCI bridge 11 to transfer USB data received to the PCI bridge 11 or to receive data transmitted from the PCI bridge 11. The USB controller 13 is connected to and controlled by the USB host controller 12 for transferring of USB-based data. The USB host controller 12 provides a USB to PCI conversion.

The microprocessor 14 is connected between the USB controller 13 and the PS2 interface connector 30 for conversion the USB-based data transferred by the USB controller 13 into PS2-based data transmitted to the PS2 interface connector 30 and conversion of the output data of the PS2 connector 30 into USB-based data transmitted to the USB controller, serving as a bridge between the USB controller 13 and the PS2 interface connector 30. Thus, the microprocessor 14 provides a conversion between the USB interface and the PS2 interface whereby the microprocessor 14 and the USB host controller 12 serve as a conversion between PS2 and PCI.

USB sound controller 15 is connected between the USB host controller 12 and the sound input connector 40 and the sound output connector 50 to convert audio data received from the sound input connector 40 into USB-based data transmitted to the USB host controller 12 and to convert the USB-based sound output from the USB host controller 12 into audio signal to the sound output device 50. Thus, the USB sound controller 15 provides a conversion between USB-based data and audio data.

The VGA chip set 16 is connected between the PCI bridge 11 and the VGA connector 60 for receiving, processing and transferring display control signals and data transmitted through the PCI bridge 11 from the host computer 200. The VGA memory 17 is coupled to the VGA chip set 16 as an expansion memory for the VGA chip set 16. The VGA BIOS 18 is coupled to the VGA chip set 16 for basic input/output operation control of the VGA chip set 16. The VGA chip set provides a conversion between the VGA data and the PCI data.

Each PS2 interface connector 30 physically and electrically connects a PS2 peripheral device 31, 31′, which can be of any peripheral devices, such as a PS2 keyboard and a PS2 mouse, but not limited thereto.

The sound input connector 40 and sound output connector 50 are respectively coupled to a sound input device 41, such as a microphone, and a sound output device 51, such as a load speaker. However, the sound input and output devices 41, 52 can be any devices that are capable of receiving external audio signals and broadcasting audio signals.

The VGA connector 60 connects a VGA display 62, such as a CRT display and an LCD display.

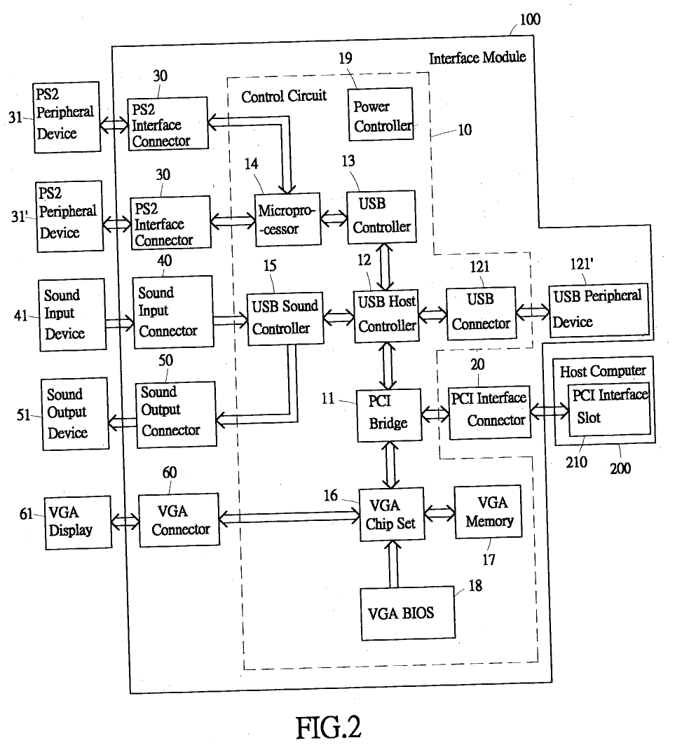

FIG. 2 shows a second embodiment of the interface module in accordance with the present invention, also designated with reference numeral 100. The interface module of the second embodiment is substantially identical to the interface module of the first embodiment, but further comprises a power controller 19 that receives electrical power from the PCI interface slot,210 of the host computer 200 via the PCI interface connector 20. The power controller 19 converts the power received from the host computer 200 into power that is suitable for and is applied to the PCI bridge 11, the USB host controller 12, the USB controller 13, the microprocessor 14, the USB sound controller 15, the VGA chip set 16, the VGA memory 17 and the VGA BIOS 18 of the control circuit 10. In addition, a USB connector 121 is additionally connected to the USB host controller 12 for selective connection with a USB peripheral device 121′. The USB peripheral device 121′ can be any USB-based peripheral devices, such as a USB printer, a USB keyboard, a USB joystick, a USB mouse, a USB scanner, a USB hub and a USB interface of another computer system.

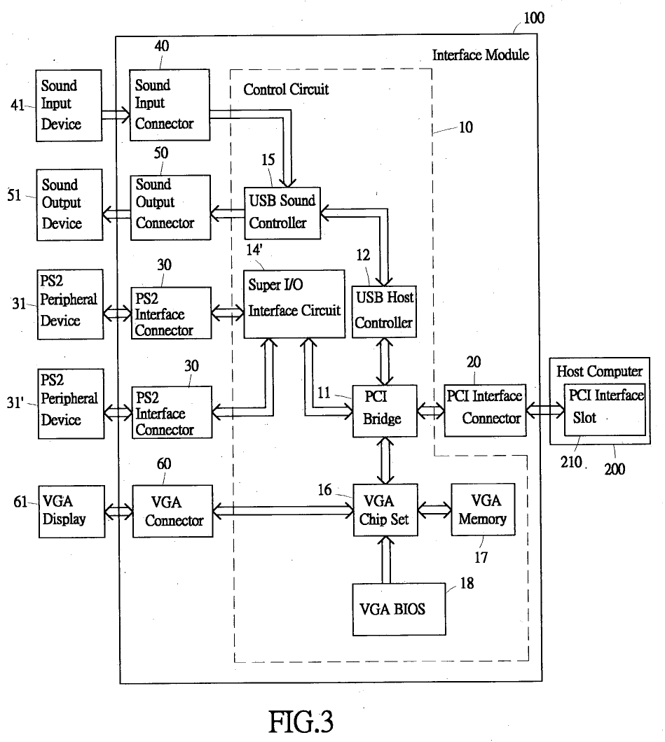

FIG. 3 shows a third embodiment of the interface module in accordance with the present invention, also designated with reference numeral 100. The interface module of the third embodiment is substantially identical to the interface module of the first embodiment, but a super I/O interface circuit 14′ replaces the microprocessor 14 and the USB controller 13 and is connected between the PCI bridge 11 and the PS2 interface connectors 30. The super I/O interface circuit 14′ converts the data and signals from the PS2 interface connectors 30 to PCI-based data and signals for the PCI bridge 11 and converts the PCI-based data and signals from the PCI bridge 11 into PS2-based data and signals for the PS2 interface connectors 30.

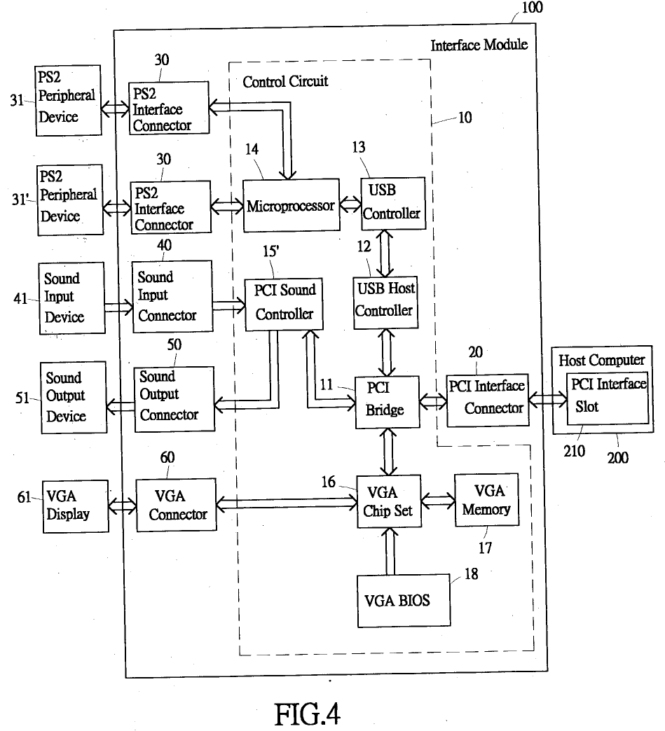

FIG. 4 shows a fourth embodiment of the interface module in accordance with the present invention, also designated with reference numeral 100. The interface module of the fourth embodiment is substantially identical to the interface module of the first embodiment, but a PCI sound controller 15′ replaces the USB sound controller 15 and connects the sound input and output devices 40, 50 to the PCI bridge 11 whereby audio data from the PCI bridge 11 is transmitted by the PCI sound controller 15′ to the sound output device 50 and whereby audio signals received by the sound input device 40 are transmitted to the PCI bridge 11 by the PCI sound controller 15′.

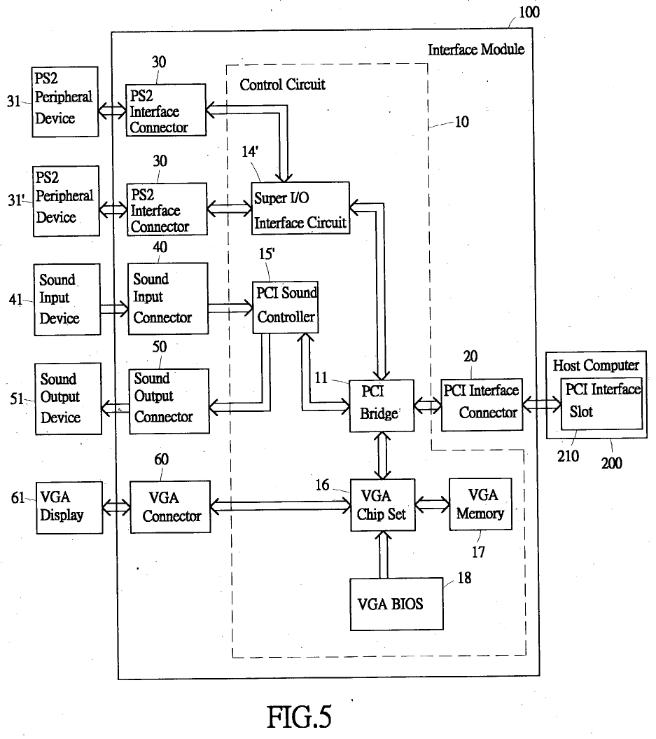

FIG. 5 shows a fifth embodiment of the interface module in accordance with the present invention, also designated with reference numeral 100. The interface module of the fifth embodiment is substantially identical to the interface module of the first embodiment, but the PCI bridge 11 is connected to the PS2 interface connectors 30 and the sound input and output connectors 40, 50 respectively by a super I/O interface circuit 14′ and a PCI sound controller 15′, which replace the microprocessor 14 and the USB controller 13 and the USB sound controller 15, respectively.

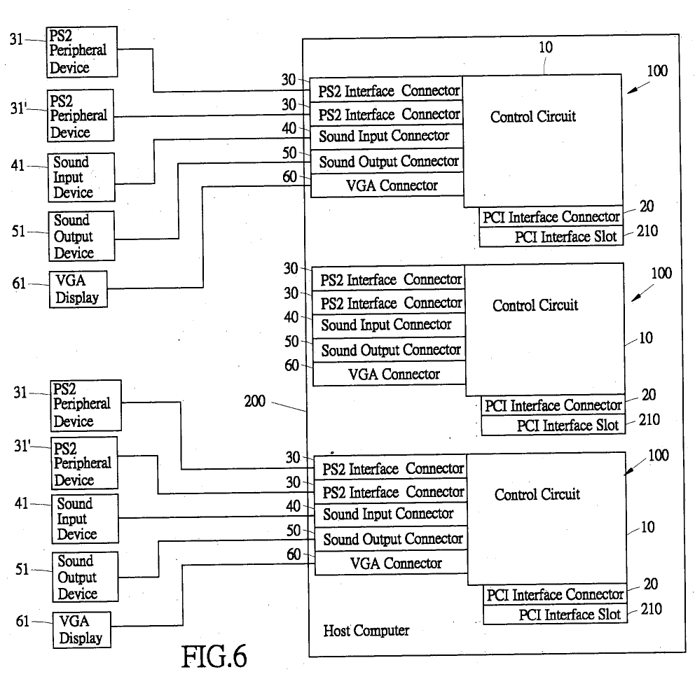

An application of the interface module 100 of the present invention is shown in FIG. 6, wherein a number of interface modules 100 of the present invention are mounted to a corresponding number of PCI interface slots 210 of a host computer 200, each interface module 100 being electrically connected to the host computer 200 by the PCI interface connector 20 thereof. Data and signals are transferred between the host computer 200 and each interface module 100 by means of the associated PCI interface slot 210. Each interface module 100 is connected to respectively PS2 peripheral devices 31, 31′, sound input device 41, sound output device 51 and VGA display 61 by means of the PS2 interface connectors 30, the sound input connector 40, the sound output connector 50 and the VGA connector 60 thereof. Thus, different computer users are allowed to control their own peripheral devices 31, 31′, sound input device 41, sound output device 51 and VGA display 61 and simultaneously share the computer resources of the computer system 200, such as application software. Also, multi-tasking operation of the computer 200 over all the PS2 peripheral devices 31, 31′, sound input and output devices 41, 51 and the VGA displays 61 can be realized.

Multi-tasking operation of the host computer 200 over the PS2 peripherals device 31, 31′, the sound input and output devices 41, 51 and the VGA display 61 is well known in the art and can be easily practiced by those skilled in the art. Thus, no further detail will be given herein.

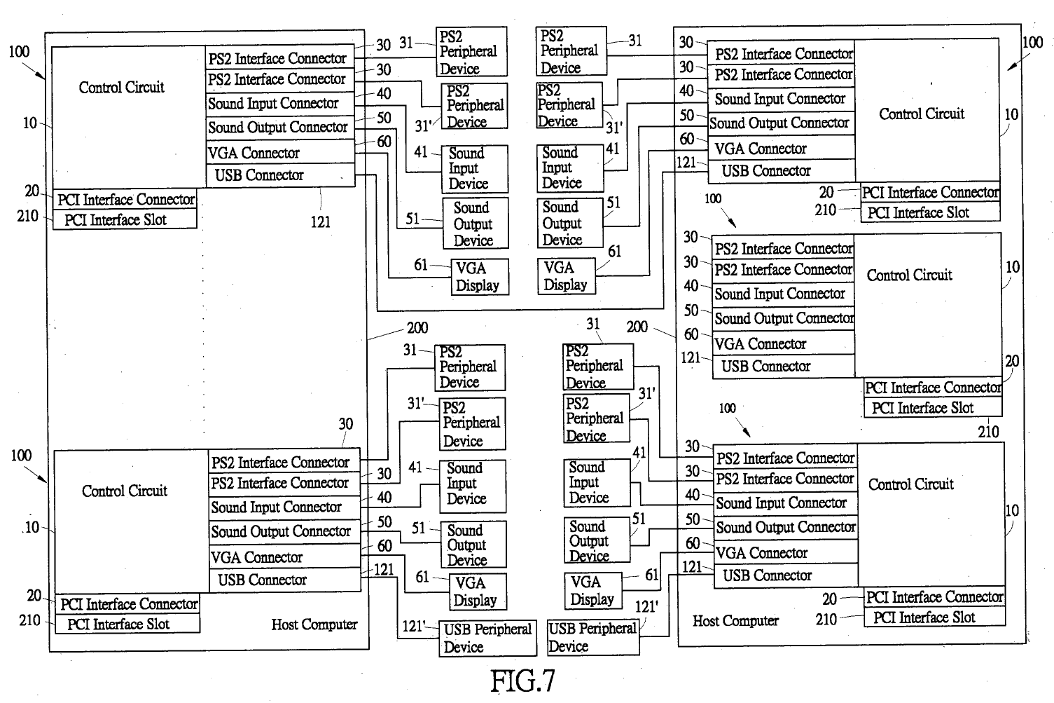

FIG. 7 shows another application of the interface module 100 of the present invention in a computer system in which two host computers are incorporated. Each host computer has a number of PCI interface slots 210 and an interface module 100 in accordance with the present invention is connected, via the PCI interface connector 20, to at least one of the PCI interface slots 210. The interface module 100 comprises a USB connector 121 as illustrated in the FIG. 2. The two host computers are connected together by means of the USB connectors 121 of the interface modules 100 associated with the host computers. In addition, USB peripherals 121′ can also be connected to the host computers by means of USB connectors 121 of other interface modules 100 connected to the host computers. Thus, resources of the two host computers can be shared among all the users of the two host computers.

To this point, it is apparent that the present invention provides a technique, which is simple and has low costs, to connect several sets of PS2 peripheral devices, sound input and output devices and VGA displays to a computer system by making use of the PCI interface slots 210 of the host computer 200 of the computer system and which allows for sharing of the computer resources among different computer users based on the multi-tasking operation of the host computer.

Although the present invention has been described with reference to the preferred embodiments thereof, it is apparent to those skilled in the art that a variety of modifications and changes may be made without departing from the scope of the present invention which is intended to be defined by the appended claims.

What is claimed is

1. An interface module comprising:
a control circuit comprising PCI to PS2 interface conversion circuitry, PCI to sound conversion circuitry and PCI to VGA display interface conversion circuitry;
a PCI interface connector connected to the control circuit and adapted to connect to a PCI interface slot of a computer for connection between the control circuit and the PCI interface slot of the computer;
at least one PS2 interface connector connected to the PCI to PS2 interface conversion circuitry of the control circuit and adapted to selectively connect a PS2 peripheral device;
a sound input connector connected to the PCI to sound conversion circuitry of the control circuit and adapted to selectively connect a sound input device;
a sound output connector connected to the PCI to sound conversion circuitry of the control circuit and adapted to selectively connect a sound output device; and
a VGA connector connected to the PCI to VGA display interface conversion circuitry of the control circuit and adapted to selectively connect a VGA display.

2. The interface module as claimed in claim 1, wherein the control circuit comprises a PCI bridge connected to the PCI connector, a USB host controller connected to the PCI bridge, a USB controller connected to the USB host controller, a microprocessor connected to the USB controller and further connected to the at least one PS2 interface connector, a USB sound controller connected to the USB host controller and further connected to the sound input connector and the sound output connectors and a VGA chip set connected to the PCI bridge and further connected to the VGA connector.

3. The interface module as claimed in claim 1, wherein the control circuit further comprises a power controller to receive electrical power from the computer via the PCI interface connector.

4. The interface module as claimed in claim 2, wherein the control circuit further comprises a USB connector connected to the USB host controller.

5. The interface module as claimed in claim 3, wherein the USB connector is adapted to selectively connect a USB peripheral device.

6. The interface module as claimed in claim 2, wherein the control circuit further comprises a VGA memory connected to the VGA chip set.

7. The interface module as claimed in claim 2, wherein the control circuit further comprises a VGA BIOS connected to the VGA chip set.

8. The interface module as claimed in claim 1, wherein the control circuit comprises a PCI bridge connected to the PCI connector, a USB host controller connected to the PCI bridge, a super I/O interface connected to the PCI bridge and further connected to the at least one PS2 interface connector, a USB sound controller connected to the USB host controller and further connected to the sound input connector and the sound output connector and a VGA chip set connected to the PCI bridge and further connected to the VGA connector.

9. The interface module as claimed in claim 8, wherein the control circuit further comprises a USB connector connected to the USB host controller.

10. The interface module as claimed in claim 9, wherein the USB connector is adapted to selectively connect a USB peripheral device.

11. The interface module as claimed in claim 8, wherein the control circuit further comprises a VGA memory connected to the VGA chip set.

12. The interface module as claimed in claim 8, wherein the control circuit further comprises a VGA BIOS connected to the VGA chip set.

13. The interface module as claimed in claim 1, wherein the control circuit comprises a PCI bridge connected to the PCI connector, a USB host controller connected to the PCI bridge, a USB controller connected to the USB host controller, a microprocessor connected to the USB controller and further connected to the at least one PS2 interface connector, a PCI sound controller connected to the PCI bridge and further connected to the sound input connector and the sound output connector and a VGA chip set connected to the PCI bridge and further connected to the VGA connector.

14. The interface module as claimed in claim 13, wherein the control circuit further comprises a USB connector connected to the USB host controller.

15. The interface module as claimed in claim 14, wherein the USB connector is adapted to selectively connect a USB peripheral device.

16. The interface module as claimed in claim 13, wherein the control circuit further comprises a VGA memory connected to the VGA chip set.

17. The interface module as claimed in claim 13, wherein the control circuit further comprises a VGA BIOS connected to the VGA chip set.

18. The interface module as claimed in claim 1, wherein the control circuit comprises a PCI bridge connected to the PCI connector, a super I/O interface connected to the PCI bridge and further connected to the at least one PS2 interface connector, a PCI sound controller connected to the PCI bridge and further connected to the sound input connector and the sound output connector and a VGA chip set connected to the PCI bridge and further connected to the VGA connector.

19. The interface module as claimed in claim 18, wherein the control circuit further comprises a VGA memory connected to the VGA chip set.

20. The interface module as claimed in claim 18, wherein the control circuit further comprises a VGA BIOS connected to the VGA chip set.
